(19) United States
(12) Patent Application Publication
(10) Pub. No.: US 2020/0295388 A1
(43) Pub. Date: Sep. 17, 2020

(54) METHOD FOR QUICKLY HEATING A FUEL CELL SYSTEM

(71) Applicant: AVL List GmbH, Graz (AT)

(72) Inventor: Vincent LAWLOR, Graz (AT)

(73) Assignee: AVL List GmbH, Graz (AT)

(21) Appl. No.: 16/652,989

(22) PCT Filed: Oct. 2, 2018
(86) PCT No.: PCT/AT2018/060230

§ 371 Date: Apr. 2, 2020

(30) Foreign Application Priority Data
Oct. 3, 2017 (AT) A50845/2017

(51) Int. Cl. H01M 8/04223; H01M 8/0612; H01M 8/04014; H01M 8/04007; H01M 8/0432; H01M 8/04701

(52) U.S. Cl. CPC H01M 8/04268; H01M 8/0618; H01M 8/04022; H01M 2250/20; H01M 8/04328; H01M 8/04738; H01M 8/04708; H01M 8/04067

(57) ABSTRACT

The invention relates to a method for heating a fuel cell system (100a) for a motor vehicle (1000), having a fuel cell stack (1) with an anode section (2), a cathode section (3), at least one evaporator (4) for evaporating a fuel/water mixture, a reformer (5) for reforming the evaporated fuel/water mixture for use in the anode section (2) of the fuel cell stack (1), and at least one burner (6) for combusting a fuel-containing fluid, wherein the reformer (5) is arranged downstream of the at least one evaporator (4) in particular, and the at least one burner (6) is arranged upstream of the at least one evaporator (4) in particular. The at least one burner (6) is fluidically connected to the at least one evaporator (4) in order to supply fuel-containing fluid combusted in the at least one burner (6) from the at least one burner (6) to the at least one evaporator (4), and a fuel/water mixture source (7) for providing a fuel/water mixture for the at least one evaporator (4) is arranged upstream of the at least one evaporator (4). The invention additionally relates to such a fuel cell system (100a) and to a motor vehicle (1000) comprising the fuel cell system (100a).

The present invention relates to a method for heating a fuel cell system, to a fuel cell system, in particular an SOFC system, and to a motor vehicle having a fuel cell system.

In general, fuel cell systems must be brought to operating temperature before they can be used to generate power. During a start of a fuel cell system, attention must be paid here to ensuring that an anode section comes into contact with oxygen as little as possible or not at all since this can lead to damage to the anode section and to a corresponding functional impairment of the fuel cell system. In order to prevent oxygen on the anode section during the starting of the fuel cell system, the anode section is flushed with water during the starting of the fuel cell system, as is known, for example, from US 2010/0203405 A1. In order to achieve this, either a water tank provided specially for the purpose or a complex water recovery system that recovers water from exhaust gas from a fuel cell stack is installed in the fuel cell system. Both solutions have proven unsatisfactory in practice.

It is the object of the present invention to at least partially take account of the problems described above. In particular, it is the object of the present invention to make available a fuel cell system, a motor vehicle and a method, by means of which or in which quick heating of the fuel cell system or of selected functional components of the fuel cell system can be achieved in a reliable manner and, in particular, in a manner which protects the anode section.

The above object is achieved by the patent claims. In particular, the above object is achieved by the method as claimed in claim 1, the fuel cell system as claimed in claim 14 and the motor vehicle as claimed in claim 29. Further advantages of the invention will emerge from the dependent claims, the description and the drawings. Here, features and details which are described in the context of the method also apply, of course, in the context of the fuel cell system according to the invention and the motor vehicle according to the invention and, in each case, vice versa, and therefore reciprocal reference is always made or can be made in respect of the disclosure of the individual aspects of the invention.

According to a first aspect of the present invention, a method for heating a fuel cell system is proposed. The fuel cell system has a fuel cell stack with an anode section and a cathode section, at least one evaporator for evaporating a fuel/water mixture, a reformer for reforming the evaporated fuel/water mixture for use in the anode section of the fuel cell stack, and at least one burner for burning a fuel-containing fluid. The reformer is preferably arranged downstream of the at least one evaporator, and the at least one burner is preferably arranged upstream of the at least one evaporator. The at least one burner is fluidically connected to the at least one evaporator in order to feed fuel-containing fluid burnt in the at least one burner from the at least one burner to the at least one evaporator. A fuel/water mixture source for providing a fuel/water mixture for the at least one evaporator is arranged upstream of the at least one evaporator.

The method has the following steps:
heating the at least one evaporator and/or a fluid within the at least one evaporator to a setpoint temperature or above,
feeding the fuel/water mixture from the fuel/water mixture source to the at least one evaporator as soon as the at least one evaporator has reached the setpoint temperature or the temperature is above the latter,
feeding a fuel/water mixture evaporated by the at least one evaporator from the at least one evaporator which has reached the setpoint temperature or the temperature of which is above the latter to the reformer for the reforming of the evaporated fuel/water mixture, and 1

feeding the reformed fuel/water mixture to the anode section, which is in a deactivated operating state, in which no current is produced by the fuel cell stack.

By means of the method according to the invention, it is possible to achieve heating of the fuel cell system, in particular heating of the at least one evaporator and of the reformer and the anode section while the anode section can be supplied with the reformed fuel/water mixture and thereby reliably protected from oxygen or at least excessive exposure to oxygen. At the same time, the fuel cell stack, in particular the anode section, is heated. By means of the delivery according to the invention of the heated and evaporated fuel/water mixture from the fuel/water mixture source to the anode section, the fuel cell system can furthermore be heated quickly.

The setpoint temperature is dependent, in particular, on what quantity of liquid fuel or liquid water/fuel mixture is evaporated or can be evaporated.

A carbon-containing fuel, e.g. methane, is used as a fuel in the fuel/water mixture. The fuel can also be formed from a premixed ethanol/water mixture. As an alternative, it is also possible to provide two containers for water and ethanol, wherein the two fuel components are mixed with one another at a later time. In this case, the fuel/water mixture can be reformed into methane, hydrogen, carbon monoxide and carbon dioxide in or on the reformer. After the reformation process, the only substances still present are particularly preferably hydrogen and methane. These substances are generally unproblematic on or in the anode section and can be burnt in an exhaust gas burner or afterburner or by means of coated components, for example. Hydrogen and methane, in particular, can furthermore be used for additional heating of the fuel cell system or of selected system components of the fuel cell system downstream of the anode section, which, as described above, is configured to temporarily not produce current.

The method is configured, in particular, to heat an SOFC system. The fuel/water mixture source can have one or more fuel/water mixture reservoirs or can be designed as such.

The evaporator can be heated or warmed by means of a heating device. The heating device can have an electric heating means and/or an oxidative heating means. It may also be expedient if the reformer and/or the evaporator are connected mechanically to the burner, so that the reformer and/or the evaporator are warmed or can be warmed by the burner by heat conduction. An efficiency of the heating process of the components of the fuel cell system is thereby further improved. The burner can therefore also be designed as a (multistage) integral component with the reformer and/or the evaporator. In this case, it is possible to dispense with a catalytic coating for an exothermic reaction of the reformer or of the evaporator.

The feeding of fluids from one system component of the fuel cell system to another system component of the fuel cell system should be interpreted to mean the delivery of the respective fluid from one system component into or onto the other system component. If the fuel/water mixture is passed from the fuel/water mixture source to the at least one evaporator, for example, the fuel/water mixture can be passed into the at least one evaporator or onto the at least one evaporator, e.g. around the at least one evaporator in thermal interaction with the at least one evaporator. Suitable delivery devices are formed in the fuel cell system for guiding or delivering the respective fluids. Moreover, the individual components of the fuel cell system are in contact with one another in such a way that thermal energy can be transferred among them. In particular, the fluids are evaporated during this process, and exothermic reactions take place, thus enabling the components to be either heated and/or held at a setpoint temperature.

The feeding of the fuel/water mixture from the fuel/water mixture source to the at least one evaporator should be interpreted to mean that the fuel/water mixture is fed at least in part from the fuel/water mixture source to the at least one evaporator. The feeding of the fuel/water mixture evaporated by the at least one evaporator from the at least one evaporator to the reformer should be interpreted to mean that the fuel/water mixture evaporated by the at least one evaporator is passed at least in part from the at least one evaporator to the reformer. The reforming of the evaporated fuel/water mixture should be interpreted to mean that the evaporated fuel/water mixture is at least partially reformed.

As soon as the fuel cell system or selected system components of the fuel cell system have reached a desired operating temperature, the fuel cell system and thus also the anode section are switched to an activated operating state, in which power is generated using reformed hydrogen.

The fact that a component according to the invention is arranged downstream or upstream of another component according to the invention should be interpreted to mean that one component is arranged directly or indirectly, that is to say possibly separated from one another by other functional components, upstream or downstream of the other component. In such an arrangement, a fluidic connection is furthermore preferably formed between the respective components. In addition or as an alternative, it is expedient if the individual components are connected to one another mechanically in order to allow heat transfer between them.

According to a development of the present invention, it is possible, in the case of one method, for the at least one burner to be designed for burning anode exhaust gas from the anode section, of cathode exhaust gas from the cathode section and/or of fuel from a primary fuel source, which is arranged upstream of the at least one burner, wherein fuel is fed to the at least one burner from the primary fuel source, and the fuel is burnt in the at least one burner, and wherein the burnt fuel is fed from the at least one burner to the at least one evaporator in order to heat the at least one evaporator and/or the fluid within the at least one evaporator to the setpoint temperature or above. The primary fuel source is required for an activated or power-generating operating state of the fuel cell system and feeds fuel to be reformed to the evaporator or the reformer. As a result, a system component which is fundamentally required in any case in the fuel cell system is used for the process according to the invention for heating the fuel cell system by means of the primary fuel source. Apart from a fluidic connection between the fuel source and the burner for feeding the fuel to the burner, it is accordingly possible to dispense with additional system components. As a result, the fuel cell system can be provided in a particularly compact form. Moreover, it is thereby possible to create a low-cost solution for heating the fuel cell system. In the burner, which is designed as an exhaust gas burner or comprises an exhaust gas burner, anode exhaust gas from the anode section, in particular, is burnt while feeding in the cathode exhaust gas, that is to say substantially air, from the cathode section. In particular, the cathode exhaust gas comprises exclusively air, whereas the anode exhaust gas comprises incompletely burnt fuel. In particular, the exhaust gas burner is an afterburner. The burner can furthermore be designed in such a way that it takes over the function of a starting burner.

In a further step, the fuel/water mixture, after acting on and/or heating the fuel cell stack, in particular the anode section, is advantageously fed to the burner. Subsequently, this fuel/water mixture is burnt in the burner. This can be performed both in its function as an exhaust gas burner and in its function as a starting burner. Subsequently, the now at least partially burnt mixture is fed to the at least one evaporator or reformer. As an alternative, it is also possible for the fuel/water mixture, after heating the anode section, to be passed directly (without an intermediate step via the burner) to an evaporator or to the reformer, wherein the evaporator and/or the reformer have/has a catalytic coating for this purpose. As a result there is an endothermic reaction, and heating of the evaporator and/or reformer is further accelerated.

Moreover, it is possible, in a method according to the invention, for the fuel to be burnt by means of an electrically activatable catalyst, in particular by means of an electrically heatable metal catalyst, of the burner, and for the catalyst to be deactivated as soon as the setpoint temperature has been reached or is exceeded. By using the activatable and deactivatable catalyst and the automatic switch-off mechanism, the burner can be operated in a particularly efficient way. The catalyst can furthermore be provided in a particularly space-saving form.

It is furthermore possible, in a method according to the present invention, for the reformed fuel/water mixture to be passed from the anode section to the at least one burner, to be at least partially burnt in the at least one burner and for the at least partially burnt fuel/water mixture to be fed from the at least one burner, via the at least one evaporator and the reformer, to the anode section. As a result, the flushing fluid used on the anode section, i.e. the evaporated and reformed fuel/water mixture, in particular the reformed combustible components thereof, can be used in the burner to heat the evaporator further. It is thereby possible to carry out the heating of the evaporator and of the reformer not only safely but also in a particularly efficient manner.

It may also be of further advantage if, in a method according to the invention, the fuel/water mixture from the fuel/water mixture source is injected into the at least one evaporator by an injector. By means of the injector, the fuel/water mixture can be injected in a simple and metered manner into the at least one evaporator. The quantity of fluid with which the anode section is to be flushed during the starting of the fuel cell system can thereby be adjusted easily. Moreover, it is thereby possible to perform any temperature adaptations to the at least one evaporator or to the reformer in a correspondingly spontaneous and simple manner by adapting an injected quantity of the reformed fuel/water mixture that is burnt by the burner by means of a desired injection process of the injector.

In a method according to the present invention, it is furthermore possible for air or some other oxygen-containing fluid to be fed to the reformer before the reforming or during the reforming of the evaporated fuel/water mixture. By feeding in air or an oxygen-containing fluid, it is possible to promote in the reformer an exothermic reaction in which even more heat can be produced in the reformer and in the anode section. As a result, the fuel cell system can be heated particularly quickly. The air can be fed in from an air source, e.g. a compressed air tank, or preferably from a blower. The blower is preferably the blower which feeds air to the cathode section. In this case, the air can be diverted into the reformer from a fluid line, which is formed between the blower and the cathode section.

It may furthermore be advantageous in a method according to the invention if the reformer is preheated before the evaporated fuel/water mixture is fed to the reformer. In a preheated reformer, the desired reforming reaction can take place in a particularly reliable manner. Unwanted reformation products, which may arise in the case of a reformer which is not being preheated, can be prevented. It is thereby possible to operate the method in a particularly stable and reliable way. For this purpose, it is possible, for example, for the reformer to be connected mechanically to the burner and to be heated by the heat of the burner by heat conduction from the burner to the reformer.

In tests in the context of the present invention, it has been found that it is advantageous if the setpoint temperature is at least 250° C., in particular at least 300° C. That is to say that the at least one evaporator and/or the fluid within the at least one evaporator are heated to at least 250° C., in particular at least 300° C., before the fuel/water mixture is passed from the fuel/water mixture source to the at least one evaporator or is injected into the latter. This temperature range has proven sufficiently high to evaporate the fuel/water mixture as desired.

According to another variant embodiment of the present invention, it is possible for at least some of the fuel/water mixture evaporated by the at least one evaporator to be passed as the fuel-containing fluid from the at least one evaporator which has reached the setpoint temperature or the temperature of which is above the latter to the at least one burner. Through the use of the evaporated fuel/water mixture, it is possible to save fuel from the fuel source or, depending on the application, to supply a particularly large amount of fuel at the burner easily and quickly. It is thereby possible for the burner and thus also the evaporator as well as the reformer to be brought quickly and easily to the desired temperature. The fact that the fuel/water mixture is to be considered as the fuel-containing fluid should be interpreted, in particular, to mean that the fuel/water mixture is used at least as part of the fuel-containing fluid fed to the burner.

Moreover, it is possible that, in the case of a method according to the invention, the fuel/water mixture evaporated by the at least one evaporator, is passed to the at least one burner in order to heat the fuel/water mixture on or in a heat exchange section of the at least one burner. In this case, the evaporated fuel/water mixture is, in particular, guided in a fluid duct which is arranged at least in some section or sections along the burner, preferably resting directly against the latter, to an inlet section for allowing the fuel/water mixture into the burner. It is thereby possible, in a simple, effective and efficient manner, to transfer heat produced in the burner to the fuel/water mixture, thus enabling the latter to be introduced into the burner after it has already been preheated and/or further evaporated. It is thereby possible to heat the burner even more quickly, thereby, in turn, also enabling the fuel/water mixture that is passed into the at least one burner via the heat exchange section to be heated even more strongly. By means of the teaching under discussion, a particularly efficient and effective heating circuit can consequently be created.

With a method according to the present invention, it is furthermore possible for a fuel source for supplying a fuel for the at least one evaporator to be arranged upstream of the at least one evaporator, wherein fuel evaporated by the at least one evaporator is passed as the fuel-containing fluid to the at least one burner in order to heat the fuel on or in a heat exchange section of the at least one burner. That is to say that, in addition or as an alternative to the fuel/water mixture source, a separate fuel source is arranged, wherein, in this case too, heat produced in the burner can be transferred to the fuel in a simple, effective and efficient manner. This enables the fuel to be introduced into the burner after it has already been preheated and/or further evaporated. It is thereby possible, in turn, to heat the burner particularly quickly, thereby also enabling the fuel that is passed into the at least one burner via the heat exchange section to be heated even more strongly. In a preferred embodiment, the fuel/water mixture source is provided in addition to the abovementioned fuel source, by means of which fuel/water mixture source evaporated fuel/water mixture is fed to the reformer via a separate evaporator for evaporating the fuel/water mixture, said evaporator being arranged in series with the evaporator for the fuel source. In this case, the two evaporators are each configured as two-way systems, which can be provided at relatively low cost.

In a method according to the present invention, it is furthermore possible for the fuel/water mixture and/or the fuel to be heated by an intermediate heating device, in particular an electric intermediate heating device, which is arranged downstream of the fuel/water mixture source or of the fuel source and upstream of the at least one burner, until the fuel/water mixture or the fuel has reached a predefined temperature or the temperature is above the latter. Using the intermediate heating device, it is possible to dispense with heating or preheating the burner by means of the initially mentioned fuel from the primary fuel source.

It is thereby also possible to dispense with a line system required for this purpose, which would generally necessitate more installation space than the intermediate heating device and a higher degree of complexity in the fuel cell system. Using the intermediate heating device according to the invention, it is therefore possible for the fuel cell system to be provided in a correspondingly simple and compact form. The intermediate heating device can be arranged upstream of the evaporator and/or downstream of the evaporator.

It may be of further advantage if, in a method according to the invention, the intermediate heating device is deactivated as soon as the at least one burner, a fluid in the at least one burner, the at least one evaporator and/or a fluid in the at least one evaporator have reached a predefined temperature or the temperature is above the latter. As soon as the respective predefined temperature has been reached, the intermediate heating device is no longer required. By virtue of the automatic shutdown, the fuel cell system can be operated in an energy-saving manner. In particular, it is expedient here if the components described above are connected to one another, in particular by direct mechanical means, in such a way that heat is conducted and transferred from the burner to the evaporator.

According to another aspect of the present invention, a fuel cell system for a motor vehicle is provided. The fuel cell system has a fuel cell stack with an anode section and a cathode section, at least one evaporator for evaporating a fuel/water mixture, a reformer for reforming the evaporated fuel/water mixture for use in the anode section of the fuel cell stack, and at least one burner for burning a fuel-containing fluid. The reformer is arranged downstream of the at least one evaporator, and the at least one burner is arranged upstream of the at least one evaporator. The at least one burner is fluidically connected to the at least one evaporator in order to feed fuel-containing fluid burnt in the at least one burner from the at least one burner to the at least one evaporator. A fuel/water mixture source for providing a fuel/water mixture for the at least one evaporator is arranged upstream of the at least one evaporator.

A fuel cell system according to the invention thus entails the same advantages as those described in detail with reference to the method according to the invention. The fuel cell system is preferably configured as an SOFC system. In another variant embodiment of the invention, the fuel cell system has a control unit, which is configured and designed to carry out a method as described in detail above. The control unit should be interpreted to mean an open-loop and/or closed-loop control unit for carrying out or controlling the individual method steps.

The fuel and the water in the fuel/water mixture source are provided at least temporarily in liquid form. The fuel/water mixture source preferably has a fuel/water mixture reservoir, in which a premixed fuel/water mixture is stored in the liquid state of aggregation. The fuel/water mixture is thereby stored in the fuel cell system in a particularly simple and compact manner.

In another variant embodiment of the present invention, the at least one evaporator is preferably arranged directly downstream of the fuel/water mixture source. It is thereby possible to perform rapid and simple adaptation of metering in respect of the fuel/water mixture for the at least one evaporator.

In a fuel cell system according to the invention, it is furthermore possible for the at least one evaporator to be arranged directly downstream of the at least one burner. It is thereby possible to ensure particularly effective heat transfer from the burner to the at least one evaporator, thereby enabling the fuel and/or the fuel/water mixture to be evaporated with corresponding effectiveness in or on the at least one evaporator.

It is particularly advantageous if, in the fuel cell system according to the invention, the at least one evaporator and/or the reformer is/are connected directly to the at least one burner. Thus, the evaporator and/or the reformer are connected mechanically to the burner, thereby enabling thermal transfer of heat from the burner to the evaporator or reformer by heat conduction. In this embodiment, no catalytic coatings of the evaporator and/or of the reformer are therefore necessary. It is possible to dispense with exothermic reactions for supplying heat. For example, the evaporator can be arranged directly adjoining the burner or surrounding the burner. It is always expedient if the components are arranged in such a way relative to one another that as much heat as possible is conducted thermally from the burner to the reformer and/or evaporator. In the context of the invention, the fact that the at least one evaporator and/or the reformer are/is connected directly to the at least one burner should be interpreted to mean that these components directly adjoin one another and are not arranged spaced apart; they are connected physically to one another.

In the present case, the at least one burner has, in particular, an exhaust gas burner and/or a starting burner. In particular, the starting burner is formed upstream of the exhaust gas burner, preferably directly upstream of the exhaust gas burner, and particularly preferably is connected integrally with the exhaust gas burner. At least the exhaust gas burner but generally also the starting burner are required in any case in an SOFC system according to the invention, for which reason no new or separate functional unit is required for the burner. Accordingly, the fuel cell system can be made available as a particularly compact and simple construction.

In a fuel cell system according to the invention, an air feed device, in particular a blower, for feeding air to the reformer is arranged before the reforming or during the reforming of the evaporated fuel/water mixture. The air feed device is preferably already required to feed air or oxygen-containing fluid to the cathode section. That is to say, it is possible to use a functional component of the fuel cell system which is required in any case in the fuel cell system. It is thereby possible to make available the fuel cell system in a compact and low-cost form.

As an alternative or in addition, it is advantageous if a further air feed device is provided, which feeds in air downstream of the reformer. An endothermic, partial oxidation reaction is thereby initiated in the anode, wherein a heating process is also accelerated. An anode temperature for the oxidation reaction should be higher than 250° C., in particular higher than 300° C. It is always important here that all the oxygen is burnt in the anode in order to avoid reoxidation at the anode. This is achieved if “rich” combustion takes place, i.e. if the lambda value is less than 1 (more fuel than air; deficiency of air).

In a fuel cell system according to the present invention, it is furthermore possible for the at least one burner to be designed for burning anode exhaust gas from the anode section, of cathode exhaust gas from the cathode section and/or of fuel from a fuel source, which is arranged upstream of the at least one burner, wherein the fuel source is designed to feed the fuel to the at least one burner, and the at least one burner is designed to feed the burnt fuel from the at least one burner to the at least one evaporator in order to heat the at least one evaporator and/or the fluid within the at least one evaporator to the setpoint temperature or above.

The at least one burner can furthermore have an electrically activatable catalyst, in particular an electrically heatable metal catalyst for burning the fuel, wherein the catalyst is configured to be deactivated as soon as the setpoint temperature has been reached or exceeded. At least one injector for injecting the fuel/water mixture from the fuel/water mixture source into the at least one evaporator is arranged downstream of the fuel/water mixture source and upstream of the at least one evaporator. A heat exchange section, on or in which the fuel/water mixture evaporated by the at least one evaporator can be fed to the at least one burner, can be formed on an outer wall section of the at least one burner. A fuel source for supplying a fuel for the at least one evaporator can be arranged upstream of the at least one evaporator, wherein fuel evaporated by the at least one evaporator can be passed as the fuel-containing fluid to the at least one burner in order to heat the fuel at or in a heat exchange section of the at least one burner. An intermediate heating device, in particular an electric intermediate heating device, for heating the fuel/water mixture and/or the fuel can be arranged downstream of the fuel/water mixture source and/or of the fuel source and upstream of the at least one burner, wherein the intermediate heating device is configured to heat the fuel/water mixture or the fuel until the fuel/water mixture or the fuel has reached a predefined temperature or the temperature is above the latter. The intermediate heating device can be configured to be deactivated as soon as the at least one burner, a fluid in the at least one burner, the at least one evaporator and/or a fluid in the at least one evaporator have reached a predefined temperature or the temperature is above the latter. The fuel cell system thus entails the same advantages as those described above in detail with reference to the associated method according to the invention.

According to another aspect of the present invention, a motor vehicle having a fuel cell system as described above is made available. Thus, a motor vehicle according to the invention also entails the advantages described above. The motor vehicle is preferably a passenger car or a heavy goods vehicle.

Further measures that improve the invention will be found in the following description of various exemplary embodiments of the invention, which are illustrated schematically in the figures. All the features and/or advantages which emerge from the claims, the description or the drawing, including design details and spatial arrangements, may be essential to the invention, either in themselves or in various combinations.

In each case schematically:

FIG. 1 shows a block diagram to illustrate a fuel cell system according to a first embodiment of the present invention,

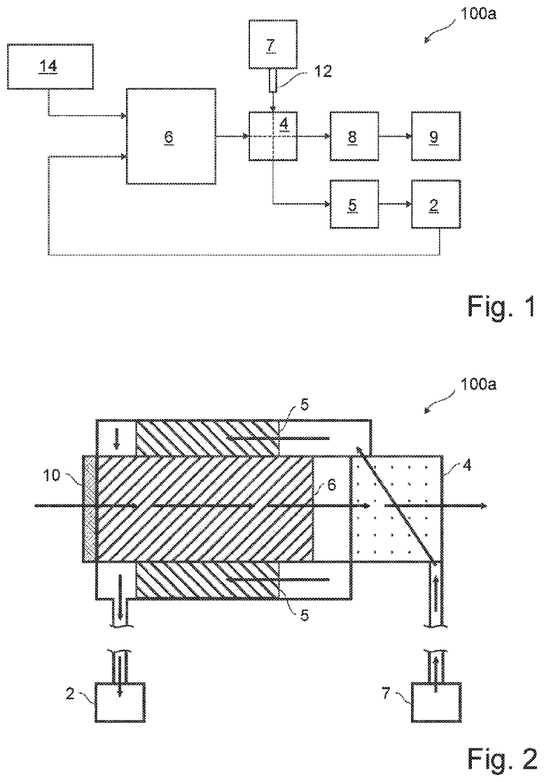

FIG. 2 shows a partially sectioned side view of a section of the fuel cell system illustrated in FIG. 1,

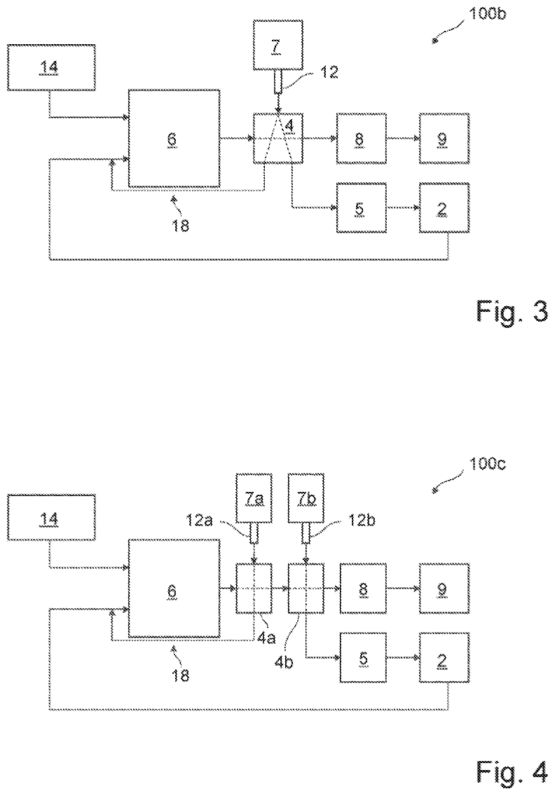

FIG. 3 shows a block diagram to illustrate a fuel cell system according to a second embodiment of the present invention,

FIG. 4 shows a block diagram to illustrate a fuel cell system according to a third embodiment of the present invention,

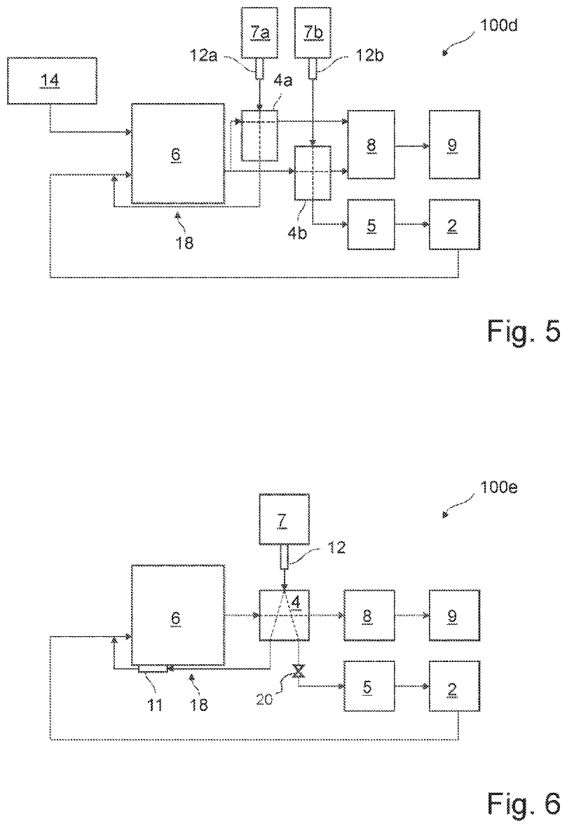

FIG. 5 shows a block diagram to illustrate a fuel cell system according to a fourth embodiment of the present invention,

FIG. 6 shows a block diagram to illustrate a fuel cell system according to a fifth embodiment of the present invention,

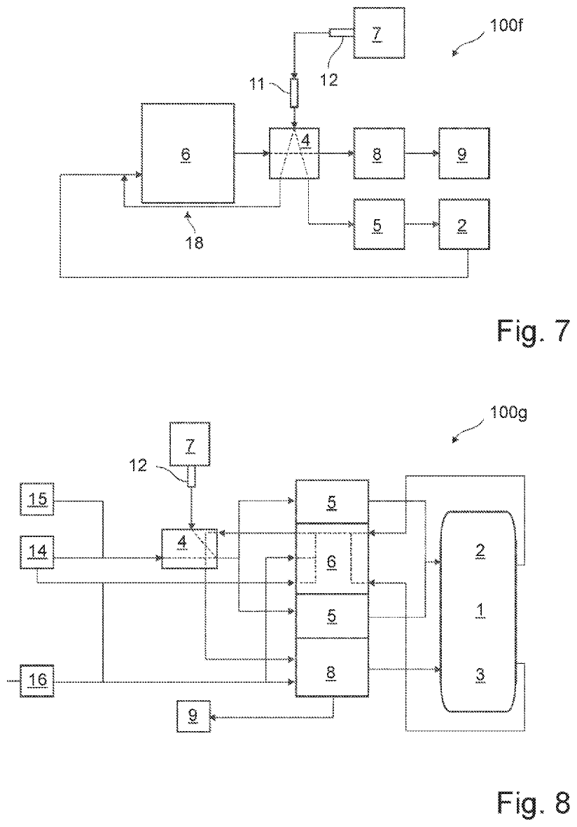

FIG. 7 shows a block diagram to illustrate a fuel cell system according to a sixth embodiment of the present invention,

FIG. 8 shows a block diagram to illustrate a fuel cell system according to a seventh embodiment of the present invention,

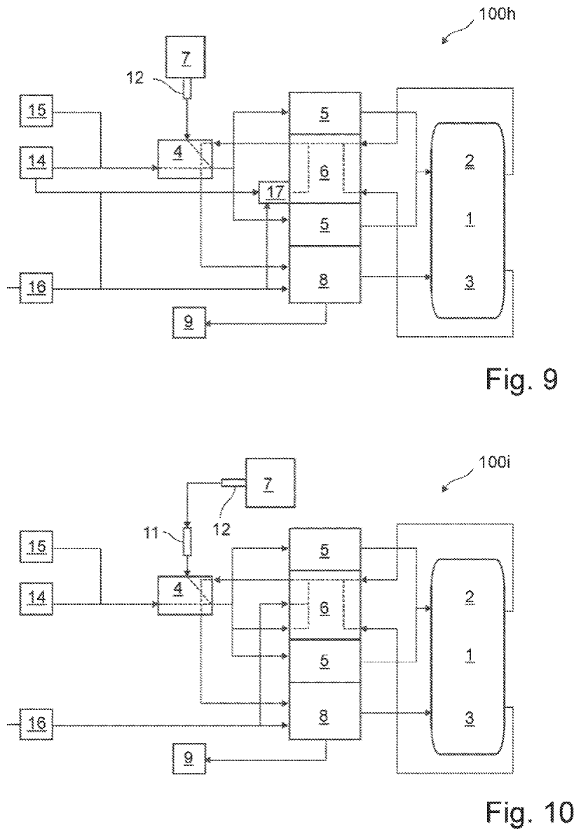

FIG. 9 shows a block diagram to illustrate a fuel cell system according to an eighth embodiment of the present invention,

FIG. 10 shows a block diagram to illustrate a fuel cell system according to a ninth embodiment of the present invention,

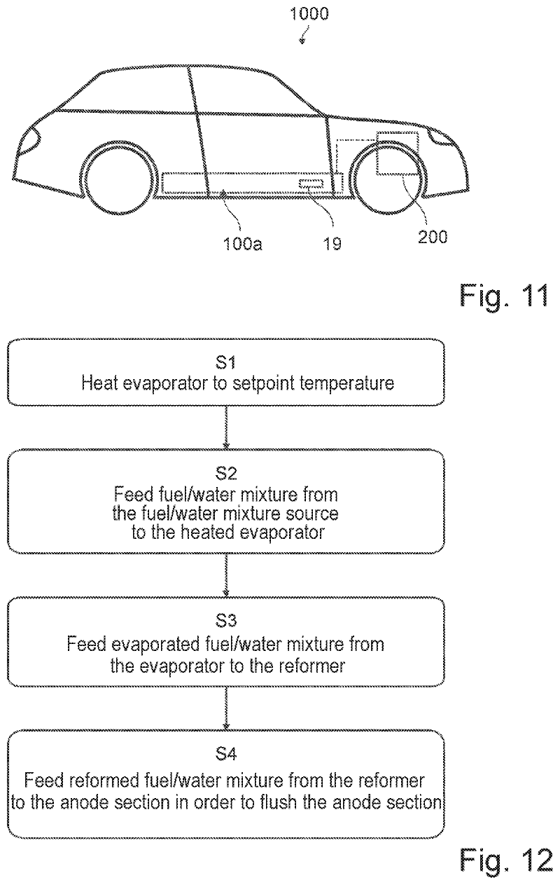

FIG. 11 shows a motor vehicle having a fuel cell system according to the invention,

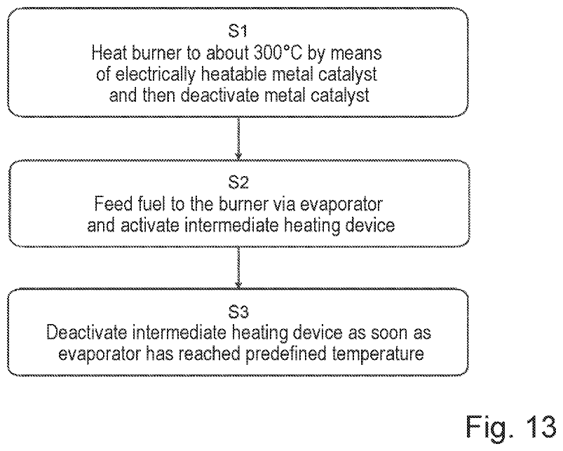

FIG. 12 shows a flow diagram to illustrate a method according to a first embodiment of the present invention, and

FIG. 13 shows a flow diagram to illustrate a method according to a second embodiment of the present invention.

Elements which have the same function and mode of operation are each provided with the same reference signs in FIGS. 1 to 13.

A fuel cell system 100a for a motor vehicle 1000 in the form of an SOFC system according to a first embodiment is illustrated schematically in FIG. 1. The fuel cell system 100a shows an anode section 2, an evaporator 4 for evaporating a fuel/water mixture, a reformer 5 for reforming the evaporated fuel/water mixture for use in the anode section 2, and a burner 6 for burning a fuel from a primary fuel source 14. The primary fuel source 14 is an optional pre-heating element such as a starting burner.

The reformer 5 is arranged downstream of the evaporator 4, and the burner 6 is arranged upstream of the evaporator 4. The burner 6 is fluidically connected or mechanically connected to the evaporator 4 in order to feed fuel burnt in the burner 6 from the burner 6 to the evaporator 4. A fuel/water mixture source 7 in the form of a fuel/water mixture reservoir is arranged directly upstream of the evaporator 4 in order to make available a fully mixed fuel/water mixture for the evaporator 4.

The fuel and the water in the fuel/water mixture source 7 are provided in liquid form. The evaporator 4 is arranged directly downstream of the fuel/water mixture source 7. The evaporator 4 is furthermore arranged directly downstream of the burner 6.

An injector 12 for injecting the fuel/water mixture from the fuel/water mixture source 7 into the evaporator 4 is arranged downstream of the fuel/water mixture source 7 and thus upstream of the evaporator 4.

A heat exchanger 8, via which burnt exhaust gas from the burner can be released into the environment 9 of the fuel cell system, is furthermore arranged directly downstream of the reformer 4.

The burner 6 is designed to feed the burnt fuel from the burner 6 to the evaporator 4 in order to heat the evaporator 4 and the fluid within the evaporator 4 to a setpoint temperature or above. Provision is advantageously made here for the burner 6 also to be physically connected to the evaporator 4, it being possible, for example, for the evaporator 4 to be arranged directly downstream of the burner 6 or around the burner 6, enclosing the latter.

With reference to FIG. 2, a section of the fuel cell system 100a according to the first embodiment is now explained in detail. The burner 6 illustrated in FIG. 2 has an electrically heatable metal catalyst for burning the fuel, wherein the catalyst is configured to be deactivated as soon as the setpoint temperature has been reached or exceeded. As illustrated in FIG. 2, the fuel/water mixture can be passed via the evaporator 4 to the reformer 5 and, from there, can be passed on to the anode section 2. In this case, the reformer 5 is arranged in a ring around the burner 6 in the form of an exhaust gas burner. A pre-heating device 10 in the form of an electric heating device for preheating fuel to be burnt in the burner 6 is arranged directly at the burner 6, upstream of the burner 6.

Further embodiments of the fuel cell system are now described with reference to FIGS. 1 to 10, although in each case only the respective features that differentiate the embodiments are explained. This is intended to avoid redundant description as far as possible.

A fuel cell system 100b according to a second embodiment is illustrated in FIG. 3. In the fuel cell system 100b illustrated, a heat exchange section 18, at which the fuel/water mixture evaporated by the evaporator 4 can be fed to the burner 6, is formed on an outer wall section of the burner 6. In FIG. 3, the fuel/water mixture is furthermore passed from the fuel/water mixture source 7 both to the burner 6 and to the reformer 5.

A fuel cell system 100caccording to a third embodiment is illustrated in FIG. 4. In the fuel cell system 100c illustrated, a fuel source 7a for providing a fuel for the first evaporator 4a is arranged upstream of a first evaporator 4a, wherein fuel evaporated by the first evaporator 4a can be passed as the fuel-containing fluid to the burner 6 in order to heat the fuel at or in the heat exchange section 18 of the burner 6. A fuel/water mixture source 7b for providing a fuel/water mixture for the second evaporator 4b is furthermore arranged upstream of a second evaporator 4b, wherein fuel/water mixture evaporated by the second evaporator 4b can be passed to the reformer 5. The second evaporator 4b is accordingly arranged upstream of the reformer 5. The first evaporator 4a and the second evaporator 4b are arranged in series and upstream of the heat exchanger 8.

A fuel cell system 100d according to a fourth embodiment is illustrated in FIG. 5, said system being similar to the fuel cell system 100caccording to the third embodiment. In the fuel cell system 100d according to the fourth embodiment, the first evaporator 4a and the second evaporator 4b are arranged parallel to one another. This can be implemented for a particularly compact construction of the fuel cell system 100d.

A fuel cell system 100e according to a fifth embodiment is illustrated in FIG. 6. In the fuel cell system 100e illustrated, an electric intermediate heating device 11 for heating the fuel/water mixture or fuel is arranged downstream of the fuel/water mixture source 7, to be more precise directly downstream of the evaporator 4, wherein the intermediate heating device 11 is configured to heat the fuel/water mixture until the fuel/water mixture has reached a predefined temperature or the temperature is above the latter. The intermediate heating device 11 is configured to be deactivated as soon as the burner 6 and/or a fluid in the burner have/has reached a predefined temperature or the temperature is above the latter. The predefined temperature can be about 650° C., for example. A valve 20 is arranged downstream of the evaporator 4 and upstream of the reformer 5. In a closed position, the valve 20 prevents fuel or the water/fuel mixture from flowing into the reformer 5 without being evaporated or being able to be evaporated. Thus, possible condensation of water/fuel mixture in the reformer 5 and flooding of the reformer 5 by liquid fuel are avoided. The valve 20 can also be provided in all the other embodiments of the invention.

A fuel cell system 100f according to a sixth embodiment is illustrated in FIG. 7. In the fuel cell system 100f illustrated, the intermediate heating device 11 is arranged downstream of the fuel/water mixture source and upstream of the evaporator 4.

As illustrated in FIGS. 3 to 7, the injector 12 is in each case arranged at a relatively long distance from the burner 6 and thereby well protected against the heat of the burner. It is therefore also possible inter alia to use a standard injector as the injector 12, i.e. an injector which does not have to meet special requirements either in its shape or in respect of temperature resistance.

A fuel cell system 100g according to a seventh embodiment is illustrated in FIG. 8. In the fuel cell system 100g illustrated, a fuel cell stack having the anode section 2 and a cathode section 3 is shown. In addition to the primary fuel source 14, a water source 15 and an air feed device 16 in the form of a blower are furthermore illustrated. The blower is configured to feed air to the reformer 5 before the reforming or during the reforming of the evaporated fuel/water mixture.

A fuel cell system 100h according to an eighth embodiment is illustrated in FIG. 9. In the fuel cell system 100h illustrated, the burner has an exhaust gas burner 6 and a starting burner 17, wherein the starting burner 17 is arranged upstream of the exhaust gas burner 6, directly at the latter.

A fuel cell system 100i according to a ninth embodiment is illustrated in FIG. 10. In the fuel cell system 100i illustrated, a fluid line to feed fuel from the primary fuel source 14 to the burner 6 has been dispensed with since the intermediate heating device 11 is arranged upstream of the evaporator 4.

In all the exemplary embodiments shown in FIGS. 8 to 10, it is also possible for just a single fuel/water mixture tank containing already premixed fuel/water mixture to be provided instead of the primary fuel source 14 and the water source 15. In principle, this fuel/water mixture tank can be designed like the fuel/water mixture source 7 and is arranged upstream of the evaporator 4.

A motor vehicle 1000 having a fuel cell system 100a according to the first embodiment is illustrated in FIG. 11. The motor vehicle 1000 furthermore has an electric motor 200, which can be driven by electric energy from the fuel cell system 100a. The motor vehicle 1000 or the fuel cell system 100a illustrated in FIG. 11 has a control unit 19, which is configured and designed to carry out a method as described in detail below.

A method according to a first embodiment is now explained with reference to FIG. 12 and FIG. 1. In a first step S1, the evaporator 4 is heated by the burner 6 to a setpoint temperature of about 300° C. During this process, fuel in the burner 6 is burnt by an electrically heatable metal catalyst, wherein the catalyst is deactivated as soon as the setpoint temperature has been reached or is or has been exceeded.

As soon as the evaporator 4 has reached the setpoint temperature or the temperature is above the latter, a fuel/water mixture is injected into the evaporator 4 from the fuel/water mixture source 7 by the injector 12 in a subsequent second step S2.

After this, in a third step S3, the reformer 5 is supplied by the evaporator 4 with a fuel/water mixture evaporated by the evaporator 4, which has reached the setpoint temperature or the temperature of which is above the latter, thus enabling the reformer to reform the evaporated fuel/water mixture. Air is fed to the reformer 5 before the reforming or during the reforming of the evaporated fuel/water mixture. The reformer 5 is furthermore preheated before the evaporated fuel/water mixture is fed to the reformer 5.

In a fourth step S4, the reformed fuel/water mixture is then fed to the anode section 2, which is in a deactivated operating state, in which no power is generated by the fuel cell stack, as a result of which the anode section is flushed and correspondingly protected during the starting and heating of the fuel cell system.

The reformed fuel/water mixture can then be passed from the anode section 2 to the burner 6 or recirculated, is at least partially burnt in the burner 6, and the at least partially burnt fuel/water mixture is fed back from the burner 6, via the evaporator 4 and the reformer 5, to the anode section 2. The corresponding heat circulation can continue until the fuel cell system has been heated to the desired temperature.

A method according to a second embodiment is now explained with reference to FIG. 13 and FIG. 6. In a first step S1, the burner 6 is heated by means of the electrically heatable metal catalyst to a setpoint temperature of about 300° C. As soon as the setpoint temperature has been reached, the metal catalyst is shut down.

In a second step S2, a fuel/water mixture is fed to the burner 6 by the injector 12 via the evaporator 4, wherein the electric intermediate heating device 11 is activated and the fuel/water mixture is guided along the burner 6.

As soon as the evaporator 4 has reached a predefined temperature, at which the fuel/water mixture can be evaporated in the desired manner by the heat produced in the burner 6, the intermediate heating device 11 is deactivated in a third step S3. In the heating circuit now present, it is possible to dispense both with the supply of power to the metal catalyst and with the supply of power to the intermediate heating device.

In addition to the embodiments illustrated, the invention admits of further design principles.

Thus, as illustrated in FIG. 4 and FIG. 5, it is possible for a fuel source 7a for supplying a fuel for the first evaporator 4a to be arranged upstream of the first evaporator 4a, wherein fuel evaporated by the first evaporator 4a is passed as the fuel-containing fluid to the burner 6 in order to heat the fuel on the heat exchange section 18 of the burner 6. That is to say that, in a method according to FIG. 13, it is also possible for a different fuel mixture or a different fuel to be fed to the burner 6 instead of the fuel/water mixture.

As illustrated in FIG. 3, FIG. 6 and FIG. 7, it is furthermore possible for at least some of the fuel/water mixture evaporated by the evaporator 4 to be passed as the fuel-containing fluid from the evaporator 4 which has reached the setpoint temperature or the temperature of which is above the latter to the burner 6. That is to say that some of the fuel/water mixture is passed from the evaporator 4 to the burner 6 and some to the reformer 5.

### LIST OF REFERENCE SIGNS

1 fuel cell stack

2 anode section

3 cathode section

4 evaporator

4a evaporator

4b evaporator

5 reformer

6 exhaust gas burner (burner)

7 fuel/water mixture source

7a fuel source

7b fuel/water mixture source

8 heat exchanger

9 environment

10 preheating device

11 intermediate heating device

12 injector

14 fuel source

15 water source

16 blower

17 starting burner (burner)

18 heat exchange section

19 control unit

20 valve

100a-100i fuel cell system

200 electric motor

1000 motor vehicle

1. A method for heating a fuel cell system (100a; 100b; 100c; 100d; 100e; 100f; 100g; 100h; 100i) having a fuel cell stack (1) with an anode section (2) and a cathode section (3), at least one evaporator (4; 4a, 4b) for evaporating a fuel/water mixture, a reformer (5) for reforming the evaporated fuel/water mixture for use in the anode section (2) of the fuel cell stack (1), and at least one burner (6, 17) for burning a fuel-containing fluid, wherein the reformer (5) is preferably arranged downstream of the at least one evaporator (4; 4a, 4b), and the at least one burner (6, 17) is preferably arranged upstream of the at least one evaporator (4; 4a, 4b), and the at least one burner (6, 17) is fluidically connected to the at least one evaporator (4; 4a, 4b) in order to feed fuel-containing fluid burnt in the at least one burner (6, 17) from the at least one burner (6, 17) to the at least one evaporator (4; 4a, 4b), and a fuel/water mixture source (7; 7a, 7b) for providing a fuel/water mixture for the at least one evaporator (4; 4a, 4b) is arranged upstream of the at least one evaporator (4; 4a, 4b), wherein the method has the following steps:
heating the at least one evaporator (4; 4a, 4b) and/or a fluid within the at least one evaporator (4; 4a, 4b) to a setpoint temperature or above,
feeding the fuel/water mixture from the fuel/water mixture source (7; 7a, 7b) to the at least one evaporator (4; 4a, 4b) as soon as the at least one evaporator (4; 4a, 4b) has reached the setpoint temperature or the temperature is above the latter,
feeding a fuel/water mixture evaporated by the at least one evaporator (4; 4a, 4b) from the at least one evaporator (4; 4a, 4b) which has reached the setpoint temperature or the temperature of which is above the latter to the reformer (5) for the reforming of the evaporated fuel/water mixture, and
feeding the reformed fuel/water mixture to the anode section (2), which is in a deactivated operating state, in which no current is produced by the fuel cell stack.

2. The method as claimed in claim 1, characterized in that the at least one burner (6, 17) is designed for burning anode exhaust gas from the anode section (2), of cathode exhaust gas from the cathode section (3) and/or of fuel from a fuel source (14), which is arranged upstream of the at least one burner (6, 17), wherein fuel is fed to the at least one burner (6, 17) from the fuel source (14), and the fuel is burnt in the at least one burner (6, 17), and wherein the burnt fuel is fed from the at least one burner (6, 17) to the at least one evaporator (4; 4a, 4b) in order to heat the at least one evaporator (4; 4a, 4b) and/or the fluid within the at least one evaporator (4; 4a, 4b) to the setpoint temperature or above.

3. The method as claimed in claim 2, characterized in that
the fuel is burnt by means of an electrically activatable catalyst, in particular by means of an electrically heatable metal catalyst, and the catalyst is deactivated as soon as the setpoint temperature has been reached or is exceeded.

4. The method as claimed in claim 1,
characterized in that
the reformed fuel/water mixture is passed from the anode section (2) to the at least one burner (6, 17), is at least partially burnt in the at least one burner (6, 17), and the at least partially burnt fuel/water mixture is fed from the at least one burner (6, 17), via the at least one evaporator (4) and the reformer (5), to the anode section (2).

5. The method as claimed in claim 1,
characterized in that
the fuel/water mixture from the fuel/water mixture source (7; 7a, 7b) is injected into the at least one evaporator (4; 4a, 4b) by an injector (12).

6. The method as claimed in claim 1,
characterized in that
air is fed to the reformer (5) before the reforming or during the reforming of the evaporated fuel/water mixture.

7. The method as claimed in claim 1,
characterized in that
the reformer (5) is preheated before the evaporated fuel/water mixture is fed to the reformer (5).

8. The method as claimed in claim 1,
characterized in that
the setpoint temperature is at least 250° C., in particular at least 300° C.

9. The method as claimed in claim 1,
characterized in that
at least some of the fuel/water mixture evaporated by the at least one evaporator (4; 4a, 4b) is passed as the fuel-containing fluid from the at least one evaporator (4; 4a, 4b) which has reached the setpoint temperature or the temperature of which is above the latter to the at least one burner (6, 17).

10. The method as claimed in claim 9,
characterized in that
the fuel/water mixture evaporated by the at least one evaporator (4; 4a, 4b) for heating the fuel/water mixture on or in a heat exchange section (18) of the at least one burner (6, 17) is passed to the at least one burner (6, 17).

11. The method as claimed in claim 1,
characterized in that
a fuel source (7a) for supplying a fuel for the at least one evaporator (4a) is arranged upstream of the at least one evaporator (4a), wherein fuel evaporated by the at least one evaporator (4a) is passed as the fuel-containing fluid to the at least one burner (6, 17) in order to heat the fuel on or in a heat exchange section (18) of the at least one burner (6, 17).

12. The method as claimed in claim 9,
characterized in that
the fuel/water mixture and/or the fuel are/is heated by an intermediate heating device (11), in particular an electric intermediate heating device (11), which is arranged downstream of the fuel/water mixture source (7; 7a, 7b) or of the fuel source (7a) and upstream of the at least one burner (6, 17), until the fuel/water mixture or the fuel has reached a predefined temperature or the temperature is above the latter.

13. The method as claimed in claim 12,
characterized in that
the intermediate heating device (11) is deactivated as soon as the at least one burner (6, 17), a fluid in the at least one burner, the at least one evaporator (4;
4a, 4b) and/or a fluid in the at least one evaporator (4; 4a, 4b) have reached a predefined temperature or the temperature is above the latter.

14. A fuel cell system (100a; 100b; 100c; 100d; 100e; 100f; 100g; 100h; 100i) for a motor vehicle (1000), having a fuel cell stack (1) with an anode section (2) and a cathode section (3), at least one evaporator (4; 4a, 4b) for evaporating a fuel/water mixture, a reformer (5) for reforming the evaporated fuel/water mixture for use in the anode section (2) of the fuel cell stack (1), and at least one burner (6, 17) for burning a fuel-containing fluid,
characterized in that
the reformer (5) is, in particular, arranged downstream of the at least one evaporator (4; 4a, 4b), and the at least one burner (6, 17) is, in particular, arranged upstream of the at least one evaporator (4; 4a, 4b), and the at least one burner (6, 17) is fluidically connected to the at least one evaporator (4; 4a, 4b) in order to feed fuel-containing fluid burnt in the at least one burner (6, 17) from the at least one burner (6, 17) to the at least one evaporator (4; 4a, 4b), and a fuel/water mixture source (7; 7a, 7b) for providing a fuel/water mixture for the at least one evaporator (4; 4a, 4b) is arranged upstream of the at least one evaporator (4; 4a, 4b).

15. (canceled)

16. The fuel cell system (100a; 100b; 100c; 100d; 100e; 100f; 100g; 100h; 100i) as claimed in claim 14,
characterized in that
the fuel and the water in the fuel/water mixture source (7; 7a, 7b) is provided at least temporarily in liquid form.

17. The fuel cell system (100a; 100b; 100c; 100d; 100e; 100f; 100g; 100h; 100i) as claimed in claim 14,
characterized in that
the at least one evaporator (4; 4a, 4b) is arranged directly downstream of the fuel/water mixture source (7; 7a, 7b).

18. The fuel cell system (100a; 100b; 100c; 100d; 100e; 100f; 100g; 100h; 100i) as claimed in claim 14,
characterized in that
the at least one evaporator (4; 4a, 4b) is arranged directly downstream of the at least one burner (6, 17).

19. The fuel cell system (100a; 100b; 100c; 100d; 100e; 100f; 100g; 100h; 100i) as claimed in claim 14,
characterized in that
the at least one evaporator (4; 4a, 4b) and/or the reformer (5) are connected directly to the at least one burner (6, 17).

20. The fuel cell system (100a; 100b; 100c; 100d; 100e; 100f; 100g; 100h; 100i) as claimed in claim 14,
characterized in that
the at least one burner has an exhaust gas burner (6) and/or a starting burner (17).

21. The fuel cell system (100a; 100b; 100c; 100d; 100e; 100f; 100g; 100h; 100i) as claimed in claim 14,
characterized in that
an air feed device (16), in particular a blower, for feeding air to the reformer (5) is arranged before the reforming or during the reforming of the evaporated fuel/water mixture.

22. The fuel cell system (100a; 100b; 100c; 100d; 100e; 100f; 100g; 100h; 100i) as claimed in claim 14,
characterized in that
the at least one burner (6, 17) is designed for burning anode exhaust gas from the anode section (2), of cathode exhaust gas from the cathode section (3) and/or of fuel from a fuel source (14), which is arranged upstream of the at least one burner (6, 17), wherein the fuel source (14) is designed to feed the fuel to the at least one burner (6, 17), and the at least one burner (6, 17) is designed to feed the burnt fuel from the at least one burner (6, 17) to the at least one evaporator (4; 4a, 4b) in order to heat the at least one evaporator (4; 4a, 4b) and/or the fluid within the at least one evaporator (4; 4a, 4b) to the setpoint temperature or above.

23. The fuel cell system (100a; 100b; 100c; 100d; 100e; 100f; 100g; 100h; 100i) as claimed in claim 14,
characterized in that
the at least one burner (6, 17) has an electrically activatable catalyst, in particular an electrically heatable metal catalyst for burning the fuel, wherein the catalyst is configured to be deactivated as soon as the setpoint temperature has been reached or exceeded.

24. The fuel cell system (100a; 100b; 100c; 100d; 100e; 100f; 100g; 100h; 100i) as claimed in claim 14,
characterized in that
at least one injector (12) for injecting the fuel/water mixture from the fuel/water mixture source (7; 7a, 7b) into the at least one evaporator (4; 4a, 4b) is arranged downstream of the fuel/water mixture source (7; 7a, 7b) and upstream of the at least one evaporator (4; 4a, 4b).

25. The fuel cell system (100a; 100b; 100c; 100d; 100e; 100f; 100g; 100h; 100i) as claimed in claim 14,
characterized in that
a heat exchange section (18), on or in which the fuel/water mixture evaporated by the at least one evaporator (4; 4a, 4b) can be fed to the at least one burner (6, 17), is formed on an outer wall section of the at least one burner (6, 17).

26. The fuel cell system (100a; 100b; 100c; 100d; 100e; 100f; 100g; 100h; 100i) as claimed in claim 14,
characterized in that
a fuel source (7a) for supplying a fuel for the at least one evaporator (4a) is arranged upstream of the at least one evaporator (4a), wherein fuel evaporated by the at least one evaporator (4a) can be passed as the fuel-containing fluid to the at least one burner (6, 17) in order to heat the fuel at or in a heat exchange section (18) of the at least one burner (6, 17).

27. The fuel cell system (100a; 100b;
100c; 100d; 100e; 100f; 100g; 100h; 100i) as claimed in claim 14,
characterized in that
an intermediate heating device (11), in particular an electric intermediate heating device (11), for heating the fuel/water mixture and/or the fuel is arranged downstream of the fuel/water mixture source (7; 7a, 7b) and/or of the fuel source (7a) and upstream of the at least one burner (6, 17), wherein the intermediate heating device (11) is configured to heat the fuel/water mixture or the fuel until the fuel/water mixture or the fuel has reached a predefined temperature or the temperature is above the latter.

28. The fuel cell system (100a; 100b; 100c; 100d; 100e; 100f; 100g; 100h; 100i) as claimed in claim 27,
characterized in that
the intermediate heating device (11) is configured to be deactivated as soon as the at least one burner (6, 17), a fluid in the at least one burner, the at least one evaporator (4; 4a, 4b) and/or a fluid in the at least one evaporator (4; 4a, 4b) have reached a predefined temperature or the temperature is above the latter.

29. A motor vehicle (1000) having a fuel cell system (100a; 100b; 100c; 100d; 100e; 100f; 100g; 100h; 100i) as claimed in claim 14.
